(19) United States
(12) Patent Application Publication
(10) Pub. No.: US 2009/0290070 A1
(43) Pub. Date: Nov. 26, 2009

(54) SYSTEMS AND METHODS FOR REMOTE VIDEO PRODUCTION

(75) Inventors: Eric Duke, Bronxville, NY (US); Leandro Blanco, Stanhope, NJ (US)

Correspondence Address: TROUTMAN SANDERS LLP;BANK OF AMERICA PLAZA, 600 PEACHTREE STREET, N.E., SUITE 5200, ATLANTA, GA, 30308-2216, US

(73) Assignee: All Mobile Video, New York, NY (US)

(21) Appl. No.: 12/469,542

(22) Filed: May 20, 2009

Related U.S. Application Data
(60) Provisional application No. 61/054,751, filed on May 20, 2008.

(51) Int. Cl. H04N 5/222

(52) U.S. Cl. 348/722; 348/E05.022

(57) ABSTRACT

The present invention describes systems and methods for remote video production. In an exemplary embodiment, the present invention provides a remote video production system including a first portal. The first portal includes a number of ports, the ports configured to receive taking place at a studio. Furthermore, the first portal includes a multiplexer configured to communication signals from equipment designed to capture a performance combine the communication signals into a transport stream. Additionally, the first portal includes at least one transmitter configured to transmit the transport stream to a location remote from the first portal.

### CROSS REFERENCE TO RELATED APPLICATION

This application claims the benefit of U.S. Provisional Application No. 61/054,751, filed 20 May 2008, which is hereby incorporated by reference in its entirety as if fully set forth below.

### FIELD OF THE INVENTION

The present invention relates generally to systems and methods for video production and, more particularly, to a communication portal for remote feeds from various communication equipment typically employed with remote broadcasting.

### BACKGROUND

Movie, television, and video production costs are driven by a number of factors, which largely involve equipment, personnel, and transportation costs. A primary goal of many remote broadcasting projects involves attempting to minimize the amount of equipment and personnel that must be transported to a remote site to enable video production. Unfortunately, the majority of conventional systems require a large amount of on-site editing, switching, mixing, and recording equipment, which must be operated on-site by technical and production personnel.

Generally, video production involves the use of cameras, microphones and other communications equipment located where a “performance” is being made by “talent”. A “performance” could be a rehearsed or live show, a speech, a news event a sporting event or any other event that could be of interest to broadcasters. The “talent” could be one or more actors, athletes, news personalities, other persons or things taking part in the “performance”. The location of the performance is often a formal studio, but can be any performance location including an outdoor area. The term “studio” is thus used here to describe any performance location.

A “control room” is the location where technical and production personnel direct, control, record and/or broadcast a performance. This control room has conventionally been located physically near the studio and connected by many wires that carry the video, audio, communication and control signals to and from the studio. In the case of mobile (remote) television production, a portable control room, typically located in a large truck or trailer is brought close enough to the Studio to permit such connections. In the case of a mobile production, this conventional approach requires bringing the large amount of expensive control room equipment and personnel to each remote site.

Additionally, when covering a production such as a news story, various different broadcasting networks will send their own people and their own expensive control room equipment to the location of the production. Not only is this expensive for each network, but it results in jockeying for position/location by the control room trucks, which causes a potentially hazardous environment.

Therefore, it would be advantageous to provide an apparatus and method for efficiently and effectively enabling remote video production.

Additionally, it would be advantageous to provide an apparatus and method to minimize the amount of equipment required at a remote production site.

Additionally, it would be advantageous to provide an improved system and method to minimize the number of technical personnel required at a remote production site.

### BRIEF SUMMARY

Embodiments of the present invention provide systems and methods for minimizing the amount of control equipment required to be transported to a remote location for capturing a performance that takes place at a studio or site, which is remote from the control room.

In an exemplary embodiment, the present invention provides a remote video production system including a first portal. The first portal includes a number of ports, and the ports are configured to receive communication signals from equipment designed to capture a performance taking place at a studio. Furthermore, the first portal includes a multiplexer configured to combine the communication signals into a transport stream. Additionally, the first portal includes at least one transmitter configured to transmit the transport stream to a location remote from the first portal.

Another exemplary embodiment of the present invention provides a method for remote video production. The method includes capturing a performance by equipment located proximal to the performance and transmitting communication signals from equipment to a first portal. Furthermore, the method involves multiplexing the communication signals in the first portal into at least one transport stream and transmitting the transport steam from the first portal to a location remote from the first portal.

These and other objects, features and advantages of the present invention will become more apparent upon reading the following specification in conjunction with the accompanying drawing figures.

### BRIEF DESCRIPTION OF THE FIGURES

FIG. 1 is a block diagram of a remote video production system 100 in accordance with an exemplary embodiment of the present invention.

FIG. 2 is a block diagram of a remote video production system 100 in accordance with an exemplary embodiment of the present invention enabling production of multiple performances with multiple studio portals 105A and 105B.

FIG. 3 is a block diagram of a remote video production system 100 in accordance with an exemplary embodiment of the present invention enabling production of multiple performances with one studio portal 105.

FIG. 4 is a block diagram of a remote video production system 100 in accordance with an exemplary embodiment of the present invention enabling production involving multiple control rooms, 120A and 120B.

FIG. 5 is a block diagram of a remote video production system 100 in accordance with an exemplary embodiment of the present invention enabling production of multiple performances with multiple studio portals 105A and 105B and multiple control rooms, 120A and 120B.

FIG. 6 provides an illustration of a flow chart of the method for remote video production 600 in accordance with an exemplary embodiment of the present invention.

### DETAILED DESCRIPTION

The embodiments of the present invention address the deficiencies in the prior art concerning the inability to minimize the need for broadcasting control room equipment at performance locations. Significantly, the present invention provides methods and apparatus for minimizing the control room equipment and staff that must be present to broadcast an event at a studio or other performance location. Additionally, the present invention overcomes the drawbacks of the conventional methods and systems in the prior art and provides systems and methods enabled to allow a centrally located control room to operate and control equipment located at multiple different remote studios. Furthermore, the present invention enables equipment at a studio location to be controlled by more than one control room.

The embodiments of the present invention provide various advantages over conventional systems. These embodiments can minimize the need for a broadcasting network to (i) transport large amounts of expensive equipment to or near a studio, or (ii) transport control room personnel to or near the studio. As a result, transportation costs may be reduced, wear and tear on equipment may be reduced, maintenance costs may be reduced, set-up and tear-down times may be reduced and operation may be more consistent and thus more reliable.

Embodiments of the present invention relate to systems and methods for minimizing the amount of remote broadcasting equipment required for mobile broadcasting events. For ease of explanation, the remainder of the description shall be limited to a description of television broadcasting of a news event from a remote location (as opposed to from the home studio). However, those skilled in the art will recognize that the description could be applied to other types of broadcasting events as well.

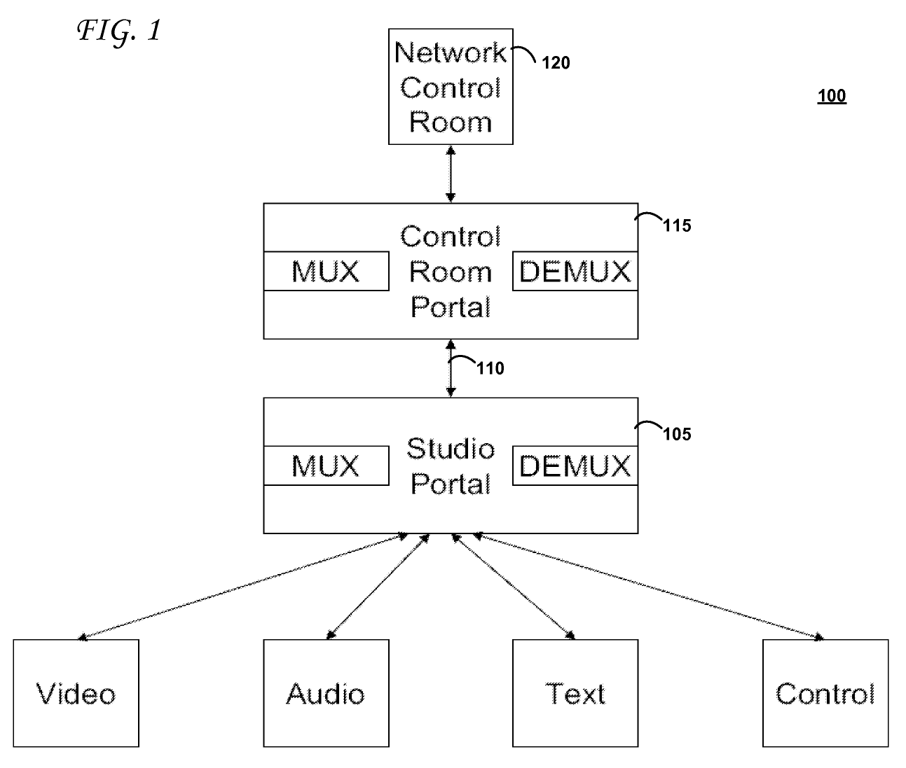

FIG. 1 is a block diagram of a remote video production system 100 in accordance with an exemplary embodiment of the present invention. As illustrated in FIG. 1, in an exemplary embodiment of the remote video production system 100, multiple streams of communication signals (e.g. video, audio, text and control, etc.) can be fed to a studio portal 105. These streams can be fed to the studio portal 105 using a variety of suitable communication mediums, including fiber optic cables, copper wires, coaxial cable, conventional over the air protocols or a combination thereof. In an exemplary embodiment, the studio portal 105 can provide a number of ports capable of receiving the communication signals. Those of skill in the art will appreciate that these ports can be a variety of different termination devices enabled to receive communication signals. In an exemplary embodiment of the studio portal 105, the communication streams are multiplexed into at least one transport stream 110. In an exemplary embodiment, the transport stream 110 can then be transmitted to the network control room. Those of skill in the art will appreciate, the multiplexed signal of the transport stream 110 may be transmitted via fiber optics, satellite, copper or any other conventional medium for transmission. For example, and not limitation, two or more Ti lines can be utilized to provide the transmission path for the transport stream 110. In an exemplary embodiment, the control room portal 115 is configured to de-multiplex the transport stream 110. The control room portal 115 in an exemplary embodiment can de-multiplex the transport stream 110 into the discrete communication signals and supply those signals to various control room 120 equipment for processing and use by the control room equipment. Typical control room 120 equipment includes but is in no way limited to one or more video switcher(s), audio mixing console(s), character generator(s), video recorder(s), audio recorder(s), camera remote control panels, tally(s) for indicating an active camera, routers, video monitors and speakers. Those skilled in the art will recognize that not every control room 120 will include the same equipment and that a control room 120 may include some or all of the above equipment or additional equipment and still fall within the scope of the present invention.

In an exemplary embodiment, the control room 120 can communicate with the studio and the equipment at the studio via the same control room portal 115 and studio portal 105 that provides communication signals from the studio. In an alternative exemplary embodiment, the control room 120 can communicate with the equipment at the studio via a different portal. In the exemplary embodiment in which the control 120 communicates with the equipment at the studio via the same control room portal 115 and studio portal 105, various signals can be multiplexed at the control room 120, communicated via the control room portal 115 then de-multiplexed at the studio portal 105 and transmitted to the appropriate equipment.

In addition to enabling the control room 120 to communicate downstream to the studio via a different control room portal 115, the control room 120 can be configured to communicate with the equipment in the studio via a different transport stream 110. In an exemplary embodiment, multiple transport streams 110 are provided, some transport streams 110 providing upstream traffic coming from the studio portal 105 and some transport streams 110 providing downstream traffic from the control room portal 115 to the studio portal 105. Those skilled in the art will recognize that one or more of the transport streams 110 in either direction could be provided with a discrete communication channel and still fall within the scope of the present invention. By virtue of the control room portal 115 and the studio portal 105 in an exemplary embodiment, various equipment located at the studio may be remotely controlled by the control room 120.

In a typical studio, cameras capture and transmit video and microphones capture and transmit audio. A studio could include this equipment and/or additional equipment and still fall within the scope of the present invention. A studio could include teleprompters, preamplifiers for the microphones, speakers, camera control units (CCU's), tally displays, video displays with multiviewer display driver, etc. Much and possibly all of the equipment at the studio could be remotely controlled by the control room 120. Each of the streams of communication could be encoded and or encrypted or the multiplexed stream of communication could be encoded and/or encrypted.

In the exemplary embodiment illustrated in FIG. 1, communications from a single performance are transmitted through the studio portal 105. Those of skill in the art will appreciate that FIG. 1 illustrates one exemplary embodiment of the remote video production system 100, but many different configurations are possible in which simultaneous video production is enabled for multiple performances at multiple studios.

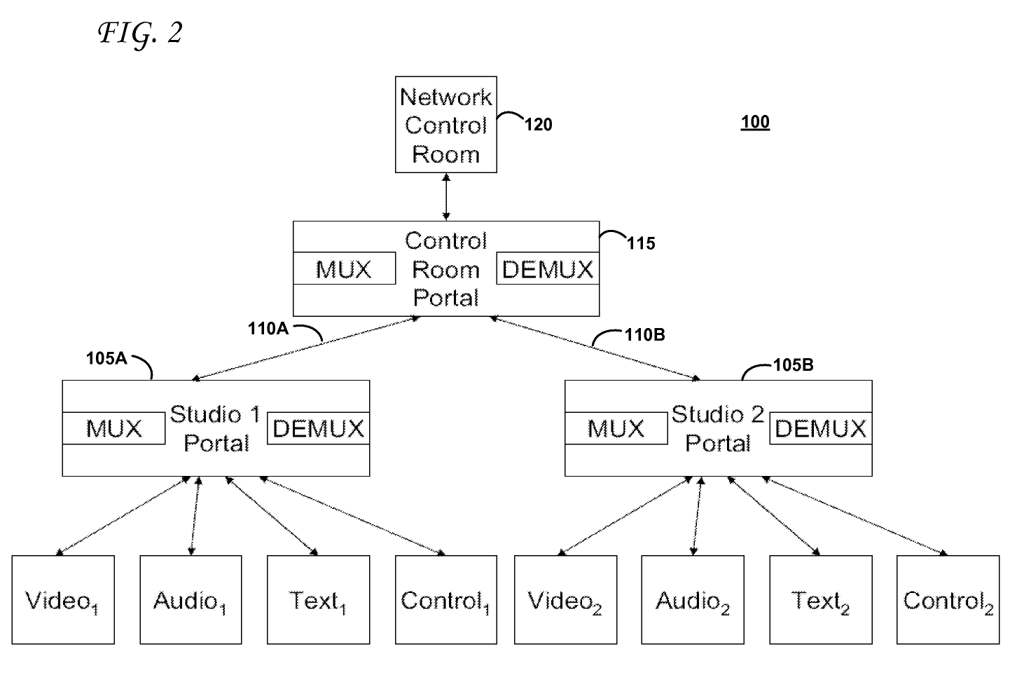

FIG. 2 is a block diagram of a remote video production system 100 in accordance with an exemplary embodiment of the present invention enabling production of multiple performances with multiple studio portals 105A and 105B. As illustrated in FIG. 2, an exemplary embodiment of the remote video production system 100 provides two studio portals, 105A and 105B, that can be configured to process communication signals originating from multiple performances. Specifically, as shown in the exemplary embodiment of FIG. 2, communication signals Video₁, Audio₁, Text₁, and Control₁, relate to a first performance and can be processed by a first studio portal 105A. Furthermore, communication signals Video₂, Audio₂, Text₂, and Control₂, relate to a second performance and can be processed by a second studio portal 105B. In this exemplary embodiment, the first studio portal 105A can multiplex the communication signals from the first performance to be transmitted via transport stream 110A to the control room portal 115. Similarly, in this exemplary embodiment, the second studio portal 105B can multiplex the communication signals from the second performance to be transmitted via transport stream 110B to the control room portal 115. Therefore, the remote video production system 100 can enable the control room 120 to simultaneously process, produce, and broadcast multiple performances at a two distantly located studios. In an exemplary embodiment, the Control₁ and Control₂ communication signals are downstream signals from the control room portal 115 that provide control signals from the control room 120 to control the equipment in the studio.

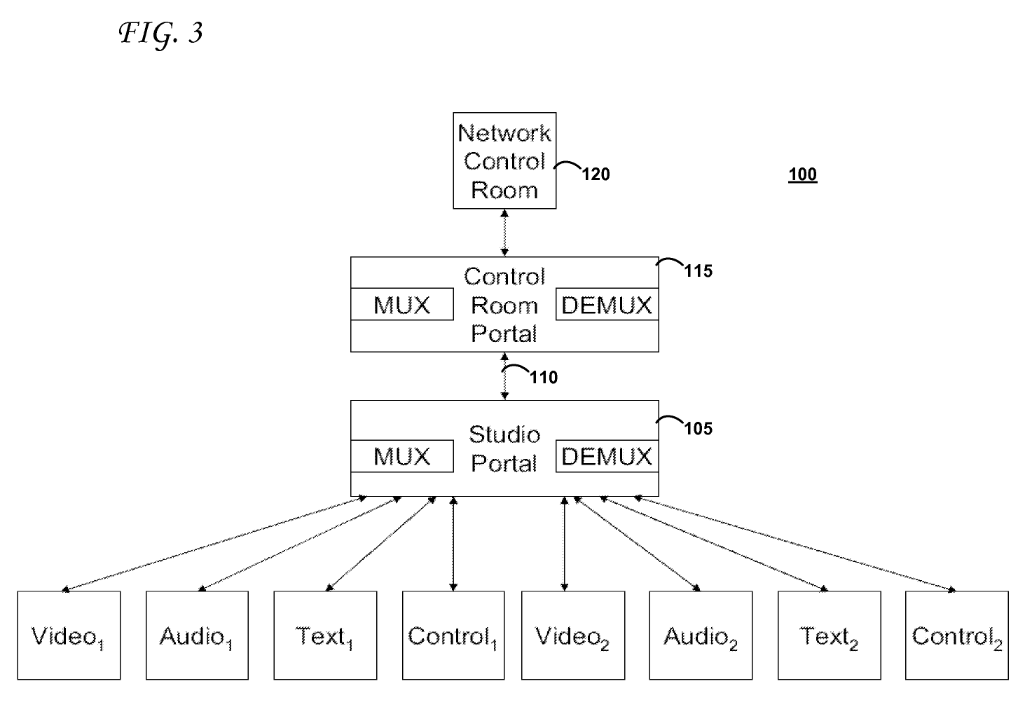

FIG. 3 is a block diagram of a remote video production system 100 in accordance with an exemplary embodiment of the present invention enabling production of multiple performances with one studio portal 105. In the exemplary embodiment shown in FIG. 3, a control room 120 employs only one studio portal 105 for two simultaneous events or non-simultaneous events. As illustrated, the communication signals from the different performances are encoded to differentiate between them. This allows the control room portal 115 and the equipment at the control room 120 to route the various signals to the proper place. Those of skill in the art will appreciate that many types of encoding are suitable for tagging various data coming from multiple performances or studios. While only two performances are illustrated, the invention is not so limited. The number of simultaneous different performances with which a portal could operate is merely a design choice.

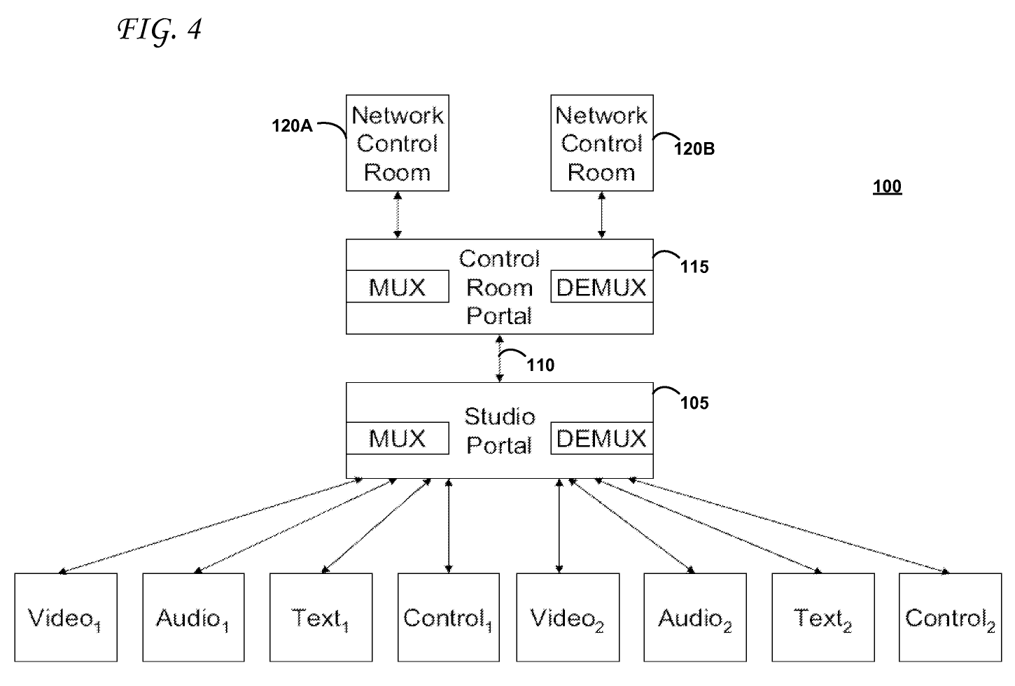

FIG. 4 is a block diagram of a remote video production system 100 in accordance with an exemplary embodiment of the present invention enabling production involving multiple control rooms, 120A and 120B. As illustrated in exemplary embodiment of the remote video production system 100 shown in FIG. 4, studio portal 105 can be controlled by multiple control rooms, 120A and 120B. For example, two different broadcasting networks could share the same portal for a common event. As illustrated in FIG. 4, and similar to the configuration of FIG. 3, the signals are encoded to differentiate between them. This allows the control room portal 115 to route the various communication signals to the proper control room, 120A or 120B. While only two control rooms, 120A and 120B, are shown in FIG. 4, those of skill in the art will appreciate that three or more control rooms could be implemented in various embodiments of the remote video production system 100. Therefore, a number of simultaneous networks can operate on a common studio portal 105 of the remote video production system 100.

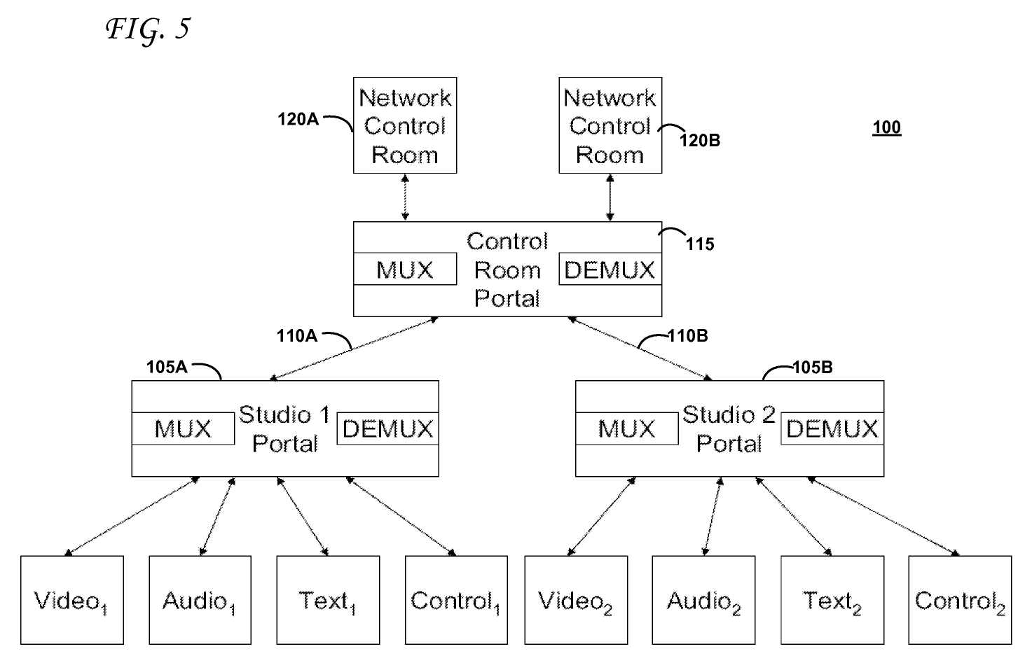

FIG. 5 is a block diagram of a remote video production system 100 in accordance with an exemplary embodiment of the present invention enabling production of multiple performances with multiple studio portals 105A and 105B and multiple control rooms, 120A and 120B. As shown in the exemplary embodiment in FIG. 5, the remote video production system 100 can be configured with a variety of different numbers of studio portals, control room portals, and control rooms. The exemplary embodiment of the remote video production system 100 shown in FIG. 5 has two studio portals, 105A and 105B, which provide two transport streams, 110A and 110B, to a control room portal 115. The control room portal 115, in an exemplary embodiment, then de-multiplexes the various equipment signals and routes them to the control rooms 120A and 120B. Therefore, in the exemplary embodiment shown in FIG. 5, either of the control rooms, 120A or 120B, can control and interact with equipment serviced by either of the studio portals 105A or 105B.

The previous examples illustrate various embodiments of the present invention. Those skilled in the art will recognize that this is not an exhaustive list. Many combinations exist that were not listed, which also fall within the scope of the invention.

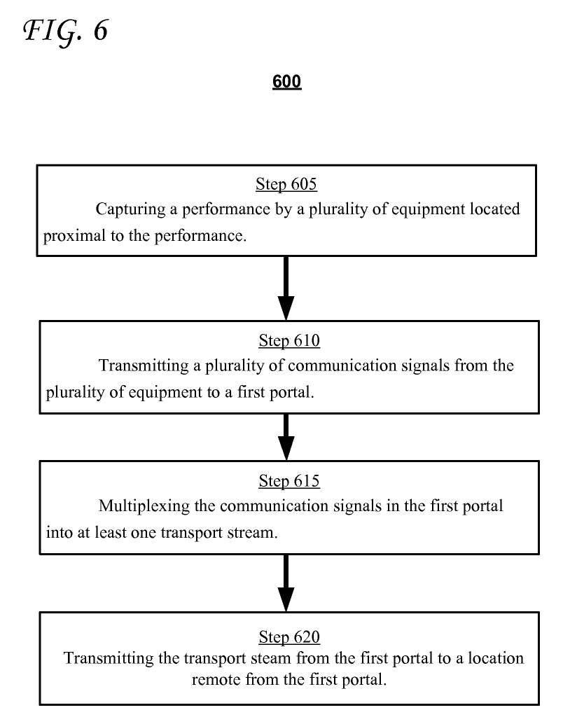

FIG. 6 provides an illustration of a flow chart of the method for remote video production 600 in accordance with an exemplary embodiment of the present invention. In accordance with an exemplary embodiment of the method for remote video production 600, the first step 605 involves capturing a performance by a plurality of equipment located proximal to the performance. The second step 610 of an exemplary embodiment of the method for remote video production 600 involves transmitting a plurality of communication signals from the plurality of equipment to a first portal. The third step 615 of an exemplary embodiment of the method for remote video production 600 involves multiplexing the communication signals in the first portal into at least one transport stream. The fourth step 620 of an exemplary embodiment of the method for remote video production 600 involves transmitting the transport steam from the first portal to a location remote from the first portal. Those of skill in the art will appreciate that the method for remote video production 600 can involve a number of additional steps to provide the functionality enabled by an exemplary embodiment of the remote video production system 100.

In accordance with exemplary embodiment of the present invention, systems and methods are provided for minimizing the amount of remote broadcasting equipment required for mobile broadcasting events. Although particular embodiments have been disclosed herein in detail, this has been done for purposes of illustration only, and is not intended to be limiting with respect to the scope of the claims, which follow. In particular, it is contemplated by the inventors that various substitutions, alterations, and modifications may be made without departing from the spirit and scope of the invention as defined by the claims. Other aspects, advantages, and modifications are considered to be within the scope of the following claims. The claims presented are representative of the inventions disclosed herein. Other, unclaimed inventions are also contemplated. The inventors reserve the right to pursue such inventions in later claims.

Insofar as embodiments of the invention described above are implemented, at least in part, using a computer system, it will be appreciated that a computer program for implementing at least part of the described methods and/or the described systems is envisaged as an aspect of the present invention. The computer system may be any suitable apparatus, system or device, electronic, optical, or a combination thereof. For example, the computer system may be a programmable data processing apparatus, a general purpose computer, a Digital Signal Processor, an optical computer or a microprocessor. The computer program may be embodied as source code and undergo compilation for implementation on a computer, or may be embodied as object code, for example.

It is also conceivable that some or all of the functionality ascribed to the computer program or computer system aforementioned may be implemented in hardware, for example by one or more application specific integrated circuits and/or optical elements. Suitably, the computer program can be stored on a carrier medium in computer usable form, which is also envisaged as an aspect of the present invention. For example, the carrier medium may be solid-state memory, optical or magneto-optical memory such as a readable and/or writable disk for example a compact disk (CD) or a digital versatile disk (DVD), or magnetic memory such as disk or tape, and the computer system can utilize the program to configure it for operation. The computer program may also be supplied from a remote source embodied in a carrier medium such as an electronic signal, including a radio frequency carrier wave or an optical carrier wave.

While the invention has been disclosed in its preferred forms, it will be apparent to those skilled in the art that many modifications, additions, and deletions can be made therein without departing from the spirit and scope of the invention and its equivalents as set forth in the following claims.

What is claimed is:

1. A remote video production system, comprising:
a first portal comprising:
a plurality of ports, the plurality of ports configured to receive a plurality of communication signals from a plurality of equipment designed to capture a first performance taking place at a studio;
a multiplexer configured to combine the plurality of communication signals into a transport stream; and
at least one transmitter in configured to transmit the transport stream to a location remote from the first portal.

2. The remote video production system according to claim 1, further comprising a second portal in the location remote from the first portal configured to receive the transport stream.

3. The remote video production system according to claim 2, wherein the second portal includes a de-multiplexer, the de-multiplexer configured to separate the transport stream into the plurality of communication signals.

4. The remote video production system according to claim 3, wherein the second portal is configured to communicate the plurality of communication signals to a control room.

5. The remote video production system according to claim 2, wherein the second portal is configured to communicate a control signal to the first portal, the control signal providing controls and instructions to the plurality of equipment at the studio.

6. The remote video production system according to claim 1, wherein the first portal is configured to receive a plurality of communication signals from a second performance.

7. The remote video production system according to claim 6, wherein the multiplexer of the first portal is configured to combine the plurality of communication signals from both the first performance and the second performance into the transport stream.

8. The remote video production system according to claim 6, wherein the multiplexer of the first portal is configured to combine the plurality of communication signals from the first performance into a first transport stream and to combine the plurality of communication signals from the second performance into a second transport stream.

9. The remote video production system according to claim 1, wherein the first portal is configured to transmit the first transport stream to a second portal in the location remote from the first portal and to transmit the second transport stream to a third portal in the location remote from the first portal.

10. A method for remote video production comprising:
capturing a performance by a plurality of equipment located proximal to the performance;
transmitting a plurality of communication signals from the plurality of equipment to a first portal;
multiplexing the communication signals in the first portal into at least one transport stream; and
transmitting the transport steam from the first portal to a location remote from the first portal.

11. The method for remote video production according to claim 10, further comprising receiving the transport stream at a second portal in the location remote from the first portal.

12. The method for remote video production according to claim 11, further comprising de-multiplexing the transport stream into the plurality of communication signals.

13. The method for remote video production according to claim 12, further comprising communicating the plurality of communication signals from the second portal to a control room.

14. The method for remote video production according to claim 11, wherein the second portal is configured to communicate a control signal to the first portal, the control signal providing controls and instructions to the plurality of equipment.
